(19) United States
(12) Patent Application Publication
(10) Pub. No.: US 2018/0214830 A1
(43) Pub. Date: Aug. 2, 2018

(54) HEATING AGITATOR HAVING SCRAPER

(71) Applicant: FUJIWARA TECHNO-ART CO., LTD., Okayama (JP)

(72) Inventors: Masahiro Kariyama, Okayama (JP); Naozumi Nishimura, Okayama (JP)

(21) Appl. No.: 15/789,327

(22) Filed: Oct. 20, 2017

(30) Foreign Application Priority Data
Jan. 31, 2017 (JP) 2017-015977

(51) Int. Cl. B01F 7/00; B01F 7/16; B01F 15/06

(52) U.S. Cl. CPC B01F 7/00208; B01F 7/165; B01F 2215/0014; B01F 2015/062; B01F 15/06

(57) ABSTRACT

Provided is a heating agitator that has a heating tank and can prevent, without complicating the structure, a raw material from remaining due to not being scraped. A scraper includes a rotation shaft tilted with respect to a center axis of the heating tank and one or a plurality of scraping units that rotate integrally with the rotation shaft. The scraping unit includes an arc-shaped member curved along a spherical bottom surface and a plurality of scraping blades fixed to the arc-shaped member. At least one of the scarping units, tips of the scraping blades are arranged such that the respective tips abut the spherical bottom surface of the heating tank along the spherical bottom surface and are in contact with a plane including a center axis of the rotation shaft. The respective tips scrape the raw material adhering to the spherical bottom surface of the heating tank while moving on corresponding concentric circles having a point as the center on the center axis of the rotation shaft.

### BACKGROUND OF THE INVENTION

### 1. Field of the Invention

The present invention relates to a heating agitator having a scraper that scrapes a raw material adhering to a spherical bottom surface of a heating tank.

### 2. Description of the Related Art

Heating agitators have been used for heating and agitating liquid or semisolid raw materials in the heating tanks thereof. In a heating agitator, a heating tank has a spherical bottom surface to be heated. A scraper is used for preventing the raw material from burning and sticking to the spherical bottom surface of the heating tank due to the heating. The scraper scrapes the raw material adhering to the bottom surface while a tip of a scraping blade thereof abuts the spherical bottom surface of the heating tank.

The heating tank should be provided with a discharge valve at the center of the bottom thereof. A rotation shaft of the scraper is, thus, tilted such that a bearing provided at an end of the rotation shaft is offset from the center of the bottom of the heating tank. A conventional heating agitator has a problem in that the raw material remains without being scraped around the bearing provided at the end of the rotation shaft regardless of whether the rotation shaft is tilted or not tilted.

The heating agitator described in Japanese Patent Application Laid-open No. 2001-232166 scrapes, by sub-scraping vanes (scraping blades), a material that is around a bearing provided at an end of a rotation shaft and is not scraped by main scraping vanes (scraping blades) fixed to an arc-shaped member. More specifically, the sub-scraping vanes are disposed on the rear side in a rotation direction of the arc-shaped member and the blades thereof are tilted on the rear side. Loci of the sub-scraping vanes on a tank wall are, thus, offset from the loci of the main-scraping vanes on the tank wall, so that the sub-scraping vanes can scrape the remaining material that is not scraped by the main-scraping vanes.

The heating agitator described in Japanese Patent Application Laid-open No. 2001-232166 needs to adjust angles of the sub-scraping vanes and shapes of the blades abutting the tank wall by fitting the actual parts to cause the sub-scraping vanes to scrape the remaining material that is not scraped by the main-scraping vanes. The heating agitator has a complicated structure, thereby causing gaps between the arc-shaped member and the respective scraping vanes to be easily clogged with solids. As a result, it is not easy to clean the arc-shaped member and the respective scraping vanes.

The present invention solves such conventional problems and aims to provide, without complicating the structure, a heating agitator having a scraper that can prevent the raw material from remaining due to not being scraped.

### SUMMARY OF THE INVENTION

For achieving the aim, a heating agitator according to the invention includes a scraper that scrapes a raw material adhering to a spherical bottom surface of a heating tank. The scraper includes a rotation shaft tilted with respect to a center axis of the heating tank and one or a plurality of scraping units that rotate integrally with the rotation shaft. The scraping unit includes an arc-shaped member curved along the spherical bottom surface and a plurality of scraping blades fixed to the arc-shaped member. In at least one of the scarping units, tips of the scraping blades are arranged such that the respective tips abut the spherical bottom surface of the heating tank along the spherical bottom surface and are in contact with a plane including a center axis of the rotation shaft. The respective tips scrape the raw material adhering to the spherical bottom surface of the heating tank while moving on corresponding concentric circles centering on the center axis of the rotation shaft.

In the heating agitator having the scraper according to the invention, at least one of the scraping units satisfies a criterion that the scraping blades fixed to the arc-shaped member are arranged such that the respective tips abut the spherical bottom surface of the heating tank along the spherical bottom surface and are in contact with the plane including the center axis of the rotation shaft. In this structure, respective points on the tips of the scraping blades move on corresponding concentric circles on the spherical bottom surface of the heating tank, the circles centering on the center axis of the rotation shaft. The respective tips of the scraping blades slide all around on the corresponding annular areas between the concentric circles on the spherical bottom surface of the heating tank, thereby making it possible to scrape the raw material adhering to the annular areas of the spherical bottom surface of the heating tank. The scraping unit is provided with a plurality of scraping blades, and thus there are a plurality of annular areas on which the scraping blades slide. If the scraping blades are arranged such that no gap is formed between the adjacent annular areas, the respective tips of the scraping blades slide all around on the whole of the spherical bottom surface of the heating tank, thereby making it possible to prevent the raw material from remaining due to not being scraped. Because it is sufficient that the shapes and mounting angles of the scraping blades are set so as to satisfy the criterion described above, the scraper can prevent, without complicating the structure, the raw material from remaining due to not being scraped.

The heating agitator having the scraper according to the invention preferably has the following respective structures. The scraping blades are preferably arranged such that the scraping blades are ahead the arc-shaped member when rotating integrally with the arc-shaped member. This structure causes the scraping blade not to be disposed directly below the arc-shaped member. As a result, the raw material does not accumulate directly below the arc-shaped member. In addition, even when the raw material accumulates on the scarping blades, the accumulated raw material is easily removed by cleaning.

It is preferable that all of the scraping units have following function. The respective tips of the scraping blades are preferably arranged such that the respective tips abut the spherical bottom surface of the heating tank along the spherical bottom surface and are in contact with the plane including the center axis of the rotation shaft, and the respective tips preferably scrape the raw material adhering to the spherical bottom surface of the heating tank while moving on the concentric circles centering on the center axis of the rotation shaft. Because this structure dispersedly arranges the scraping blades over a plurality of the scraping units, which satisfy the criterion that the scraping blades are arranged such that the tips abut the spherical bottom surface of the heating tank and are in contact with the plane including the center axis of the rotation shaft in the scraping units, it is possible to reduce a weight of each scarping unit and an agitation resistance. For example, if the scraper includes two scraping units, the scraping blades in one scraping unit are fixed with a gap between the scraping blades while the scraping blades in the other scraping unit are arranged such that the scraping blades slide the area the scraping blades in the one scraping unit do not scrape. This structure reduces the weight of each scraping unit and the agitation resistance because the raw material moves through the gap between the adjacent scraping blades when the scraping blades slide. In addition, with this structure, the strength of the rotation shaft can be reduced and the load on a motor can be reduced.

It is preferable that the scraper include the plurality of scraping units, a supporting member be disposed to the rotation shaft to be symmetrically with respect to the rotation shaft, the arc-shaped member extend from one end side of the supporting member while the arc-shaped member extend from the other end side of the supporting member in a direction opposite to the extending direction of the arc-shaped member provided to the one end side of the supporting member. This structure achieves a good weight balance, thereby stabilizing a rotation speed of the scraper and reducing the load on the motor in the rotation.

### BRIEF DESCRIPTION OF THE DRAWINGS

FIG. 1 is a vertical sectional view of a heating agitator according to an embodiment of the invention;

FIG. 2 is an enlarged perspective view illustrating a main section of a scraper of the heating agitator illustrated in FIG. 1;

FIG. 3 is a view on arrow A of the scraper in FIG. 1;

FIG. 4 is a view on arrow B of the scraper in FIG. 1; and

FIG. 5 is a view on arrow C of the scraper in FIG. 1.

### DETAILED DESCRIPTION OF THE PREFERRED EMBODIMENT

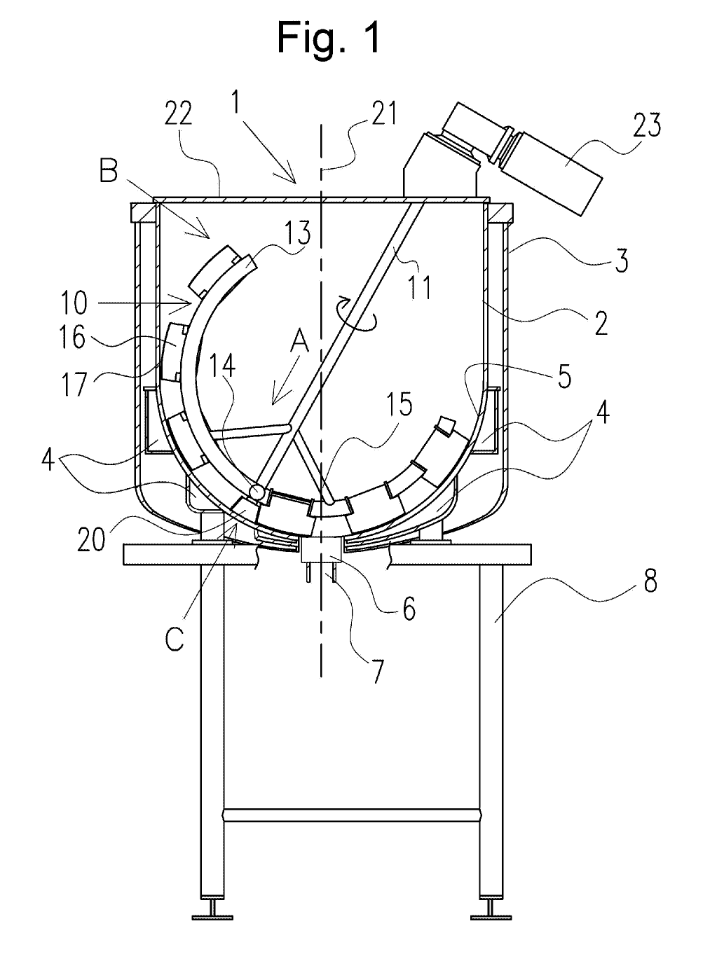

The following describes an embodiment of the invention with reference to the accompanying drawings. FIG. 1 illustrates a vertical sectional view of a heating agitator 1 having a scraper 10 according to the embodiment of the invention. The heating agitator 1 is a device that scrapes a raw material adhering to a spherical bottom surface 5 of a heating tank 2 while heating and agitating the raw material in the heating tank 2. The raw material may be a liquid raw material, a semisolid raw material, a mixture thereof, or a one to which a solid raw material, such as vegetables, fruits, and fish, are added. Examples of the liquid raw material include soy sauces, sweet cooking rice wines, alcoholic beverages, and extractives. Examples of the semisolid raw material include fermented soybean pastes, mayonnaises, roux, and sauces.

The heating agitator 1 has a tank exterior unit 3 providing an external appearance. The tank exterior unit 3 houses the heating tank 2 having a spherical bottom surface. To the heating tank 2, heating units 4 serving as heat sources heating the tank are attached. In FIG. 1, the heating units 4 are attached to the spherical bottom surface of the heating tank 2.

For example, the heating unit 4 is a tape heater or a rubber heater. For example, the heating unit 4 may be a jacket in which hot water or steam flows. When the jackets are used for the heating units 4, the jackets are provided in multiple stages. When an amount of liquid in the heating tank 2 is small, only the jacket disposed at the lower stage is used, thereby making it possible to prevent the raw material from undesired burning and sticking to the heating tank 2.

The heating tank 2 is provided with a discharge tube 7 having a valve 6 at the bottom thereof. In FIG. 1, the heating agitator 1 is supported on a rack 8. The heating agitator 1 can discharge the raw material in the heating tank 2 from the discharge pipe 7 by switching the valve 6. The rack 8 is an example. Another structure that can support the heating tank 2 may be employed.

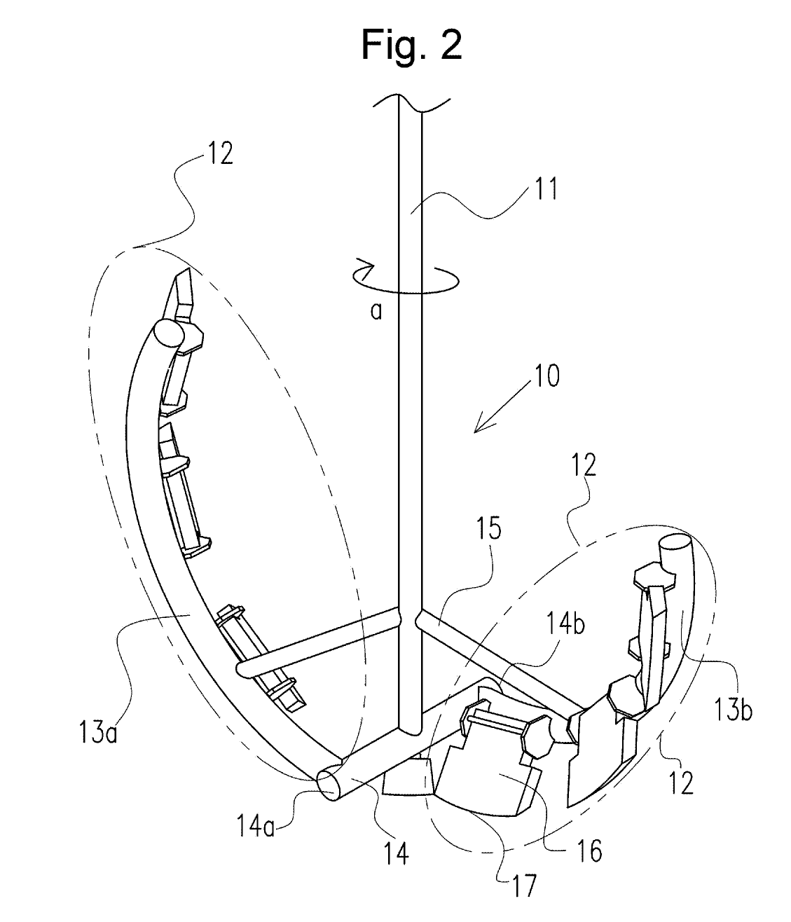

As illustrated in FIG. 1, the scraper 10 is disposed in the heating tank 2. FIG. 2 illustrates a main section of the scraper 10. The scraper 10 is an instrument that scrapes a raw material adhering to the spherical bottom surface 5 of the heating tank 2. The scraper 10 includes a rotation shaft 11 and scraping units 12 that rotate integrally with the rotation shaft 11. Each of the scraping units 12 includes an arc-shaped member 13 (in FIG. 2, an arc-shaped member 13a or an arc-shaped member 13b) curved along the spherical bottom surface of the heating tank 2 and a plurality of scraping blades 16 fixed to the arc-shaped member 13.

In FIG. 1, a front end side of the rotation shaft 11 is supported by a bearing 20 fixed to the heating tank 2 while a rear end side of the rotation shaft 11 is connected to a driving source 23 mounted above a cover 22. The rotation shaft 11 of the scraper 10 is tilted with respect to a center axis 21 of the heating tank 2. For example, the tilting angle is equal to or larger than 20 degrees and equal to or smaller than 50 degrees. The tilted rotation shaft 11 makes it possible to discharge the raw material from the center portion of the bottom surface of the heating tank 2, and to additionally provide an instrument having a vertical shaft. Examples of the instrument include a stirrer and a cutter that cuts a solid raw material.

The raw material adhering to the spherical bottom surface 5 of the heating tank 2 is scraped by the scraping blades 16 included in the scraping units 12 (refer to FIG. 2). For example, the material of the scraping blade 16 is a resin or a rubber. The raw material is mainly a food, and thus the material of the scraping blade 16 is preferably a resin such as a fluorine resin in view of foreign material mixing prevention and heat resistance. The scraping blades 16 do not necessarily have the same shape. If the scraping blades 16 have the same shape, designing, manufacturing, and maintenance are facilitated.

In FIG. 2, arrow A indicates a rotation direction of the rotation shaft 11. As illustrated in FIG. 2, the scraping blades 16 are arranged ahead the arc-shaped members 13a and 13b in the arrow A direction. In this structure, the scraping blades 16 are not disposed directly below the arc-shaped members 13. As a result, the raw material does not accumulate directly below the arc-shaped members 13a and 13b. In addition, even when the raw material accumulates on the scarping blades 16, the accumulated raw material is easily removed by cleaning.

In FIG. 2, a supporting member 14 is interposed between the rotation shaft 11 and the respective scraping units 12. The supporting member 14 is disposed symmetrically with respect to the rotation shaft 11. The arc-shaped members 13a and 13b are fixed to both ends of the supporting member 14. The arc-shaped member 13a extends from one end 14a side of the supporting member 14. The arc-shaped member 13b extends from other end 14b side of the supporting member 14 in a direction opposite to the extending direction of the arc-shaped member 13a provided on the one end 14a side of the supporting member 14. This structure achieves a good weight balance, thereby stabilizing the rotation of the scraper 10 and reducing a load on a motor in the rotation.

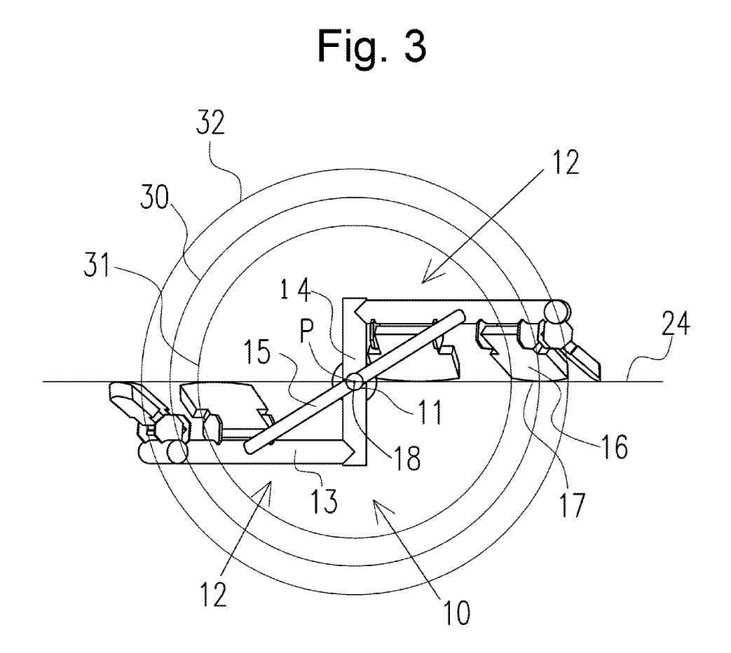

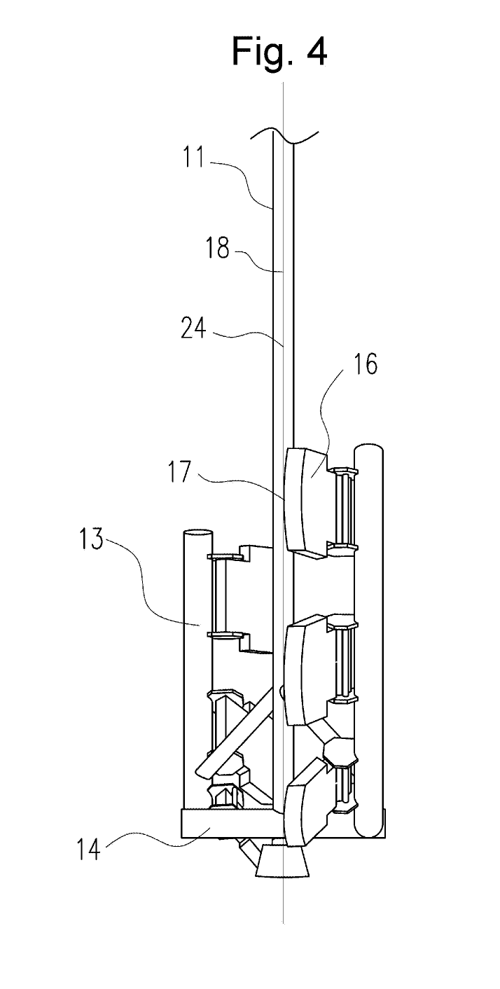

In FIG. 1, tips 17 of the scraping blades 16 abut the spherical bottom surface 5 of the heating tank 2 along the spherical bottom surface 5. The tips 17, thus, each have an arc shape. The following describes the tip 17 with reference to FIGS. 3 and 4. FIG. 3 is a view on arrow A of the scraper 10 in FIG. 1. FIG. 3 illustrates the scraper 10 when viewed from a direction in parallel with the rotation shaft 11. FIG. 4 is a view on arrow B of the scraper 10 in FIG. 1. FIG. 4 illustrates the scraper 10 when viewed from a direction perpendicular to the rotation shaft 11.

In FIG. 3, the tips 17 of the scraping blades 16 are arranged such that the tips 17 are in contact with a plane 24 including a center axis 18 of the rotation shaft 11. In FIG. 4, the tips 17 of the scraping blades 16 are also arranged such that the tips 17 are in contact with the plane 24 including the center axis 18 of the rotation shaft 11. As described above, the tips 17 abut the spherical bottom surface 5 of the heating tank 2 along the spherical bottom surface 5. Taking one of the scraping blades 16 in FIG. 3 as an example in this structure, a part in contact with the plane 24 of the tip 17 moves on a circle 30 having a point P as the center on the center axis 18 of the rotation shaft 11, one end of the tip 17 moves on a circle 31 having the point P as the center, and the other end of the tip 17 moves on a circle 32 having the point P as the center. Each of the other parts of the tip 17 also moves on a circle having the point P as the center.

In this structure, the respective points on the tip 17 move on concentric circles on the spherical bottom surface 5 of the heating tank 2, the circles having the point P as the center. As a result, the tip 17 slides all around on an annular area between the circles 31 and 32 on the spherical bottom surface 5 of the heating tank 2, thereby making it possible to scrape the raw material adhering to the spherical bottom surface 5 of the heating tank 2. The scraping unit 12 is provided with a plurality of scraping blades 16, and thus there are annular areas on which the scraping blades 16 slide. If the scraping blades 16 are arranged such that no gap is formed between the adjacent annular areas, the tips 17 of the scraping blades 16 move all around on the whole of the spherical bottom surface 5 of the heating tank 2, thereby making it possible to prevent the raw material from remaining without being scraped.

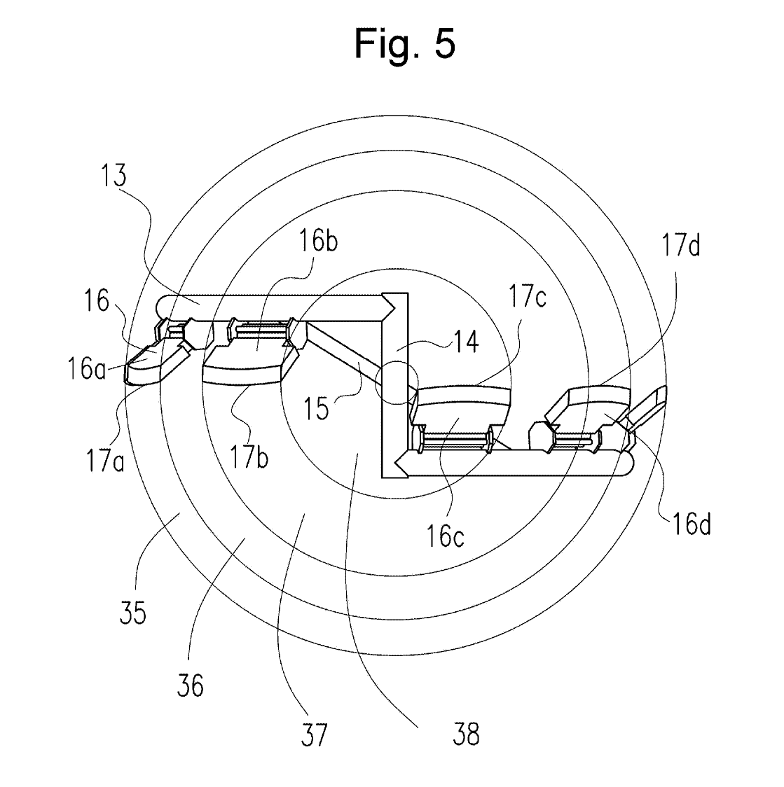

The embodiment satisfies a criterion that the scraping blades 16 included in each of the two scraping units 12 are arranged such that the respective tips 17 abut the spherical bottom surface 5 of the heating tank 2 along the spherical bottom surface 5 and are in contact with the plane 24 including the center axis 18 of the rotation shaft 11. Because this structure dispersedly arranges the scraping blades 16 satisfying the criterion over a plurality of scraping units 12, it is possible to reduce a weight of each scarping unit 12 and an agitation resistance. In the embodiment, the scraping blades 16 in one scraping unit 12 are fixed such that a gap is provided between the scraping blades 16 while the scraping blades 16 in the other scraping unit 12 are arranged such that the scraping blades 16 scrape the areas on which the scraping blades 16 in the one scraping unit 12 do not slide, which is described later in detail with reference to FIG. 5. This structure reduces the weight of each scraping unit 12 and the agitation resistance because the raw material moves through the gap between the adjacent scraping blades 16 when the scraping blades 16 slide. In addition, with this structure, the strength of the rotation shaft 11 can be reduced and the load on the motor can be reduced.

The prevention of not scraped and remaining raw material is specifically described with reference to FIG. 5. FIG. 5 is a view on arrow C of the scraper 10 in FIG. 1. FIG. 5 illustrates the scraper 10 when viewed from the bottom side of the heating tank 2 in a direction in parallel with the rotation shaft 11. For expository convenience, the scraping blades 16 in FIG. 3 are denoted as scraping blades 16a to 16d while the tips 17 in FIG. 3 are denoted as tips 17a to 17d. As described above, the respective tips 17 of the scraping blades 16 slide on the corresponding annular areas on the spherical bottom surface 5 of the heating tank 2 in FIG. 3. In FIG. 5, the tips 17a to 17d of the scraping blades 16a to 16d each slide on corresponding one of annular areas 35 to 38.

More specifically, in FIG. 5, the tip 17a of the scraping blade 16a slides on the annular area 35 while the tip 17b of the scraping blade 16b slides on the annular area 37. The scraping blades 16a and 16b are on the left side of the supporting member 14. The tip 17c of the scraping blade 16c slides on the annular area 38 on the inner circumference side of the annular area 37 while the scraping blade 17d of the scraping blade 16d slides on the annular area 36 between the annular areas 35 and 37. The scraping blades 16c and 16d are on the right side of the supporting member 14. The raw material adhering to the areas illustrated in FIG. 5 in the spherical bottom surface 5 of the heating tank 2 can be entirely scraped. Because the tips 17 of the other scraping blades 16 slide on areas of concentric circles, which are not illustrated in FIG. 5, outside the annular area 35 in the same manner as described above, it is possible to scrape the raw material adhering to the areas all around, and prevent the raw material from remaining due to not being scraped.

In the embodiment, the scraping blades 16 fixed to the arc-shaped members 13 are arranged such that the respective tips 17 abut the spherical bottom surface 5 of the heating tank 2 along the spherical bottom surface 5 and are in contact with the plane 24 including the center axis 18 of the rotation shaft 11. Because it is sufficient that the shapes and mounting angles of the scraping blades 16 are set so as to satisfy the criterion described above, the embodiment can prevent, without complicating the structure, the raw material from remaining due to not being scraped.

In the embodiment, the scraper 10 is provided with the two scraping units 12. The number of scraping units 12 may be one or three or more. The embodiment satisfies the criterion that the scraping blades 16 included in the scraping unit 12 are arranged such that the respective tips 17 abut the spherical bottom surface 5 of the heating tank 2 along the spherical bottom surface 5 and are in contact with the plane 24 including the center axis 18 of the rotation shaft 11. Although in the embodiment, both of the two scraping units 12 satisfy the criterion, at least one of the scraping units 12 may satisfy the criterion. Even when one of the scraping units 12 satisfies the criterion, the respective tips 17 of the scraping blades 16 slide all around on the annular areas on the spherical bottom surface 5 of the heating tank 2 as described above. Therefore, if the scraping blades 16 are arranged such that no gap is formed between the adjacent annular areas, or in the plurality of scraping units 12, the scraping blades 16 are arranged such that the annular areas partially overlap with each other, the raw material is prevented from remaining due to not being scraped.

The shape of the supporting member 14 is not limited to a straight line shape. The shape of the supporting member 14 may be an arc shape or a V-shape. The cross-sectional shape may be a round or square shape. When the supporting member 14 is a member having a straight line shape as illustrated in FIG. 2, the size of the member can to be reduced to a minimum size, and the alignment of the scraping blades 16 becomes easy because the supporting member 14 has a small strain.

Although the scraper 10 in the embodiment includes the supporting member 14, the supporting member 14 may be omitted. The scraper 10 may have a structure in which the arc-shaped members 13 extend directly from the rotation shaft 11. Although the reinforcement members 15 are bridged between the rotation shaft 11 and the respective arc-shaped members 13 for reinforcing the arc-shaped members 13, the reinforcement members 15 may be omitted.

Effect of the invention is described above. In summary, at least one of the scraping units can scrape the raw material adhering to the spherical bottom surface of the heating tank by sliding the respective tips of the scraping blades on the annular areas on the spherical bottom surface of the heating tank. If the scraping blades are arranged such that no gap is formed between the adjacent annular areas, the respective tips of the scraping blades slide all around on the whole of the spherical bottom surface of the heating tank, thereby making it possible to prevent the raw material from remaining due to not being scraped. It is sufficient that the shapes and mounting angles of the scraping blades are set so as to satisfy a certain criterion. The scraper can prevent, without complicating the structure, the raw material from remaining due to not being scraped.

### REFERENCE SIGNS LIST

1 heating agitator
2 heating tank
3 tank exterior unit
4 heating unit
5 spherical bottom surface
10 scraper
11 rotation shaft
12 scraping unit
13 arc-shaped member
14 supporting member
15 reinforcement member
16 scraping blade
16a, 16b, 16c, 16d scraping blade
17 tip
17a, 17b, 17c, 17d tip
18 center axis
21 center axis of heating tank
24 plane
30, 31, 32 circle (concentric circle)

What is claimed is:

1. A heating agitator comprising a scraper that scrapes a raw material adhering to a spherical bottom surface of a heating tank, wherein
the scraper includes:
a rotation shaft tilted with respect to a center axis of the heating tank; and
one or a plurality of scraping units that rotate integrally with the rotation shaft,
the scraping unit includes an arc-shaped member curved along the spherical bottom surface and a plurality of scraping blades fixed to the arc-shaped member, and
in at least one of the scarping units, tips of the scraping blades are arranged such that the respective tips abut the spherical bottom surface of the heating tank along the spherical bottom surface and are in contact with a plane including a center axis of the rotation shaft, and the respective tips scrape the raw material adhering to the spherical bottom surface of the heating tank while moving on corresponding concentric circles centering on the center axis of the rotation shaft.

2. The heating agitator according to claim 1, wherein the scraping blades are arranged such that the scraping blades are ahead the arc-shaped member when rotating integrally with the arc-shaped member.

3. The heating agitator according to claim 1, wherein, in all of the scraping units, the respective tips of the scraping blades are arranged such that the respective tips abut the spherical bottom surface of the heating tank along the spherical bottom surface and are in contact with the plane including the center axis of the rotation shaft, and the respective tips scrape the raw material adhering to the spherical bottom surface of the heating tank while moving on the concentric circles centering on the center axis of the rotation shaft.

4. The heating agitator according to claim 1, wherein
the scraper includes the plurality of scraping units,
a supporting member is disposed to the rotation shaft to be symmetrically with respect to the rotation shaft,
the arc-shaped member extends from one end side of the supporting member while the arc-shaped member extends from the other end side of the supporting member in a direction opposite to the extending direction of the arc-shaped member provided to the one end side of the supporting member.
